(19) United States
(12) Patent Application Publication
(10) Pub. No.: US 2009/0310612 A1
(43) Pub. Date: Dec. 17, 2009

(54) Global Communications Ring Backbone

(75) Inventor: Stephen F. Froelich, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 11/917,606

(22) PCT Filed: Sep. 20, 2007
(86) PCT No.: PCT/US2007/079055

§ 371 Date: Dec. 14, 2007

(51) Int. Cl. H04L 12/56

(52) U.S. Cl. 370/400

(57) ABSTRACT

Embodiments of a global communications ring backbone (102/104) that encircles Earth are provided.

### BACKGROUND

As business in global markets increases, the desire for businesses and individuals to easily communicate with others in remote global locations increases. Existing global communications networks, such as the Internet, however, typically do not provide reliable mechanisms for ensuring timely delivery of latency-sensitive data such as voice, audio/video, and streaming media data. The global connections that make up the Internet are generally a patchwork of interconnected networks that are independently administered. Because of the independent administration, it may be difficult to obtain a consistent communications path between endpoints on the Internet that can effectively serve latency-sensitive applications. The problem can be compounded when the endpoints include remote global locations. It would be desirable to be able to reliably transmit latency-sensitive data to remote global locations.

### BRIEF DESCRIPTION OF THE DRAWINGS

FIGS. 1A-1B are diagrams illustrating an embodiment of a global communications network with global communications ring backbones.

FIGS. 2A-2C are tables illustrating embodiments of node interconnections of global communications ring backbones.

FIG. 3 is a flow chart illustrating an embodiment of a method for routing data on a global communications ring backbone.

FIG. 4 is a flow chart illustrating an embodiment of a method for routing data from a global communications ring backbone.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

According to one embodiment, a global communication network includes one or more global communications ring backbones that encircle the Earth. The network transmits latency-sensitive data between media sites to allow real time communications between any two connected sites on Earth.

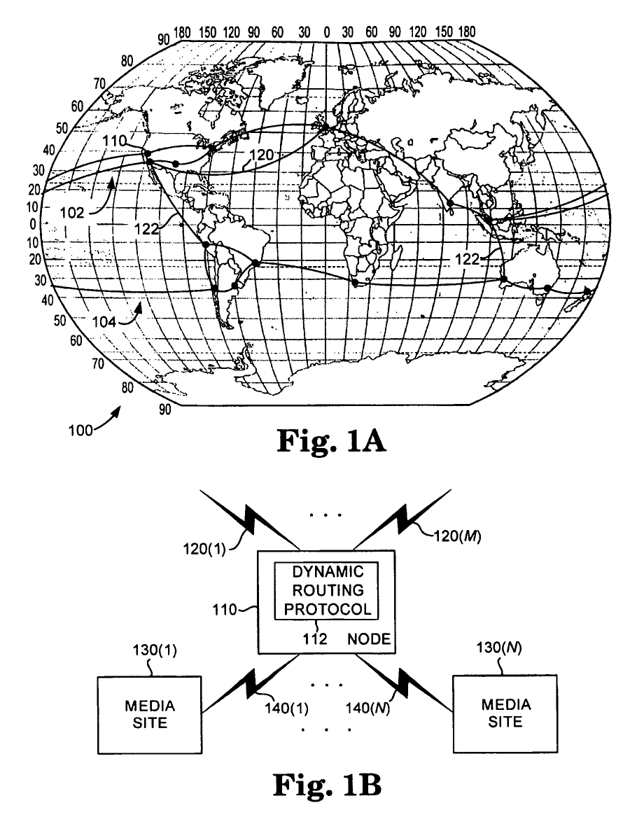

FIGS. 1A-1B are diagrams illustrating an embodiment of a global communications network 100 with global communications ring backbones 102 and 104. Referring to FIG. 1A, global communications ring backbones 102 and 104 each include nodes 110 connected with links 120 to form a ring communications network that encircles the Earth. Nodes 110 of backbone 102 are located in the northern hemisphere (i.e., north of the equator) such that backbone 102 encircles the North Pole in the northern hemisphere, and nodes 110 of backbone 104 are located in the southern hemisphere (i.e., south of the equator) such that backbone 104 encircles the South Pole in the southern hemisphere. Backbones 102 and 104 are interconnected with links 122.

Communications network 100 is configured to transmit latency-sensitive data between media sites 130 (shown in FIG. 1B). The latency-sensitive data may include media data such as voice, audio/video (A/V), and rich media streaming data. In one embodiment, communications network 100 transmits A/V data from a video teleconference between two or more media sites 140 connected to two or more nodes 110. Because the data is latency-sensitive, each backbone 102 and 104 is configured to guarantee a maximum average latency of 1 millisecond per degree of longitude of the Earth to ensure that an overall maximum latency between any two nodes 110 on a backbone 102 or 104 remains below 360 milliseconds. In addition, because every pair of nodes 110 in a backbone 102 or 104 is separated by 180 degrees of longitude or less, each backbone 102 and 104 includes at least one path between any two nodes 110 in a backbone 102 or 104 with a maximum latency of 180 milliseconds.

Backbones 102 and 104 provide the latency guarantees by strategically locating nodes 110 and maintaining control of the operation of nodes 110 and links 120. The locations of nodes 110 are selected to position the overall routes of backbones 102 and 104 near the middle of most of the population of Earth and minimize the distance of links 120 between nodes 110 in each backbone 102 and 104. Because most of the population resides between the equator and approximately the 50^{th} parallel (i.e., 50 degrees of latitude) in the northern and southern hemispheres, the locations of nodes 110 of backbones 102 and 104 may be selected to be between the equator and approximately the 50^{th} parallel in each hemisphere, respectively, so that the routes of backbones 102 and 104 pass as near as possible to most of the population in one embodiment. In addition, an operator of backbones 102 and 104 maintains control of the operation of nodes 110 and links 120 by setting configurations and routing policies of nodes 110 and links 120 to ensure the latency guarantees. The operator may set these configurations and policies directly and/or by entering into lease or other contractual agreements with the owners or administrators of nodes 110 and links 120.

In one embodiment, each backbone 102 and 104 is a trunk connection that forms a larger transmission line that carries data gathered from smaller lines 140 that interconnect media sites 130 with backbone 102 or 104 and encircles the world at least once between the equator and optimally less than 50 degrees of latitude on one side of the equator.

Nodes 110 are each configured to receive data from other nodes 110 across links 120 and 122, media sites 130 across connections 140, or other network devices (not shown) and transmit the data to other nodes 110, media sites 130, or other network devices (not shown). Each node 110 includes any suitable type and combination of one or more network devices such as a router, a switch, a gateway, a firewall, and a bridge. In one embodiment, each node 110 is located in a caged area at a carrier hotel and connects to leased lines of one or more telecommunications providers where the leased lines form links 120. Each carrier hotel includes mass communications equipment (e.g., fiber optic lines, routing and switching equipment, and power supplies) of telecommunications providers that allows for secure interconnection between the equipment of providers and the equipment of other providers and/or third parties. Each carrier hotel may be located in a population center such as a major city or in another suitable location. In other embodiments, nodes 110 may be situated in other locations and connect to other owned or leased lines that form links 120.

Links 120 and 122 may each be any suitable transmission link or combination of redundant or non-redundant transmission links that allows communication between connected nodes 110. Each link 120 and 122 may be formed from any suitable transmission medium (e.g., optical fiber, copper, and free space) and may transmit data using any suitable transmission protocol. In one embodiment, each link 120 and 122 is an optical fiber link configured to transmit light signals between nodes 110. In other embodiments, each link 120 and 122 is a wired or wireless link configured to transmit electromagnetic signals between nodes 110. Links 120 and 122 may be any suitable combination of leased lines from telecommunications providers and lines owned by an operator of backbones 102 and 104 or by a third party.

Each backbone 102 and 104 includes at least two redundant communication paths that extend between each pair of nodes 110 in a backbone 102 or 104 that partially circle the Earth in generally opposite directions along the ring formed by the backbone 102 or 104. The communication paths include the links 120 that connect to the pair of nodes 110 and any intermediate links 120 that connect to intermediate nodes 110 between the pair of nodes 110 in either direction in backbone 102 or 104. Between any two nodes 110 within backbone 102 or 104, a first path extends in a generally westward direction to connect the nodes 110 and a second path extends in a generally eastward direction to connect the nodes 110. The first path extends across a first set of lines or degrees of longitude between the nodes 110, and the second path extends across a second set of lines or degrees of longitude between the nodes 110. Because each backbone 102 and 104 forms a ring around the Earth and the paths extend in opposite directions in the ring, the first and the second sets are different and substantially mutually exclusive and the combination of the first and the second sets include all or substantially all lines of longitude of the Earth. The first and the second sets intersect only at the lines of longitude that include the pair of nodes in one embodiment. In other embodiments, the first and the second sets of longitude may also both include other lines or degrees of longitude.

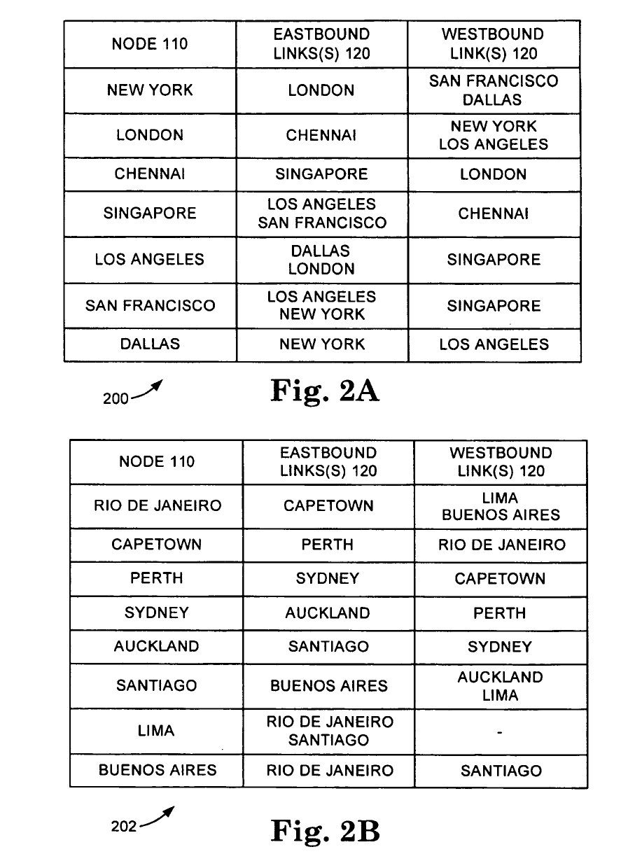

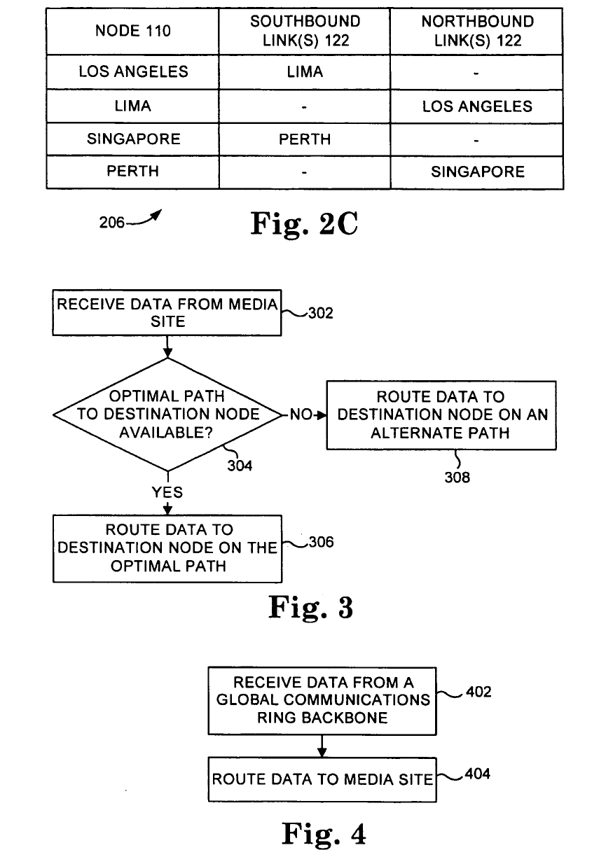

FIG. 2A is a table 200 illustrating an example of the locations and interconnections of nodes 110 in backbone 102. This example is also shown in FIG. 1A. In the example of FIG. 2A, nodes 110 are located in New York, London, Chennai, Singapore, Los Angeles, San Francisco, and Dallas. As shown in table 200, the node 110 in New York includes links 120 to and from London, San Francisco, and Dallas, and the node 110 in London includes links 120 to and from Chennai, New York and Los Angeles, and so on. Nodes 110 in each of these cities are connected to other nodes 110 in these cities with at least one generally eastbound path and at least one generally westbound path along the ring formed by backbone 102.

For example, a first westbound path between Dallas and Chennai goes from Dallas to Los Angeles, from Los Angeles to Singapore, and from Singapore to Chennai, and a first eastbound path between Dallas and Chennai goes from Dallas to New York, from New York to London, and from London to Chennai. Additional westbound paths from Dallas to Chennai may go from Los Angeles to San Francisco to Singapore (rather than from Los Angeles to Singapore directly in the above westbound example) or from Dallas to New York to San Francisco to Singapore (rather than from Dallas to Los Angeles to Singapore in the above westbound example), for example. Similarly, additional eastbound paths from Dallas to Chennai may go from Dallas to Los Angeles to London (rather than from Dallas to New York to London in the above eastbound example). The above paths are described by way of example as other paths between Dallas and Chennai are possible.

FIG. 2B is a table 202 illustrating an example of the locations and interconnections of nodes 110 in backbone 104. This example is also shown in FIG. 1A. In the example of FIG. 2B, nodes 110 are located in Rio de Janeiro, Capetown, Perth, Sydney, Auckland, Santiago, Lima, and Buenos Aires. As shown in table 202, the node 110 in Rio de Janeiro includes links 120 to and from Capetown, Lima, and Buenos Aires, and the node 110 in Capetown includes links 120 between Perth and Rio de Janeiro, and so on. Nodes 110 in each of these cities are connected to other nodes 110 in these cities with at least one generally eastbound path and at least one generally westbound path along the ring formed by backbone 104. Many example eastbound and westbound paths between nodes 110 in backbone 104 may be constructed in this example in the manner described above with reference to FIG. 2A.

As noted above, backbones 102 and 104 include any number of connections between nodes 110 in backbone 102 and nodes 110 in backbone 104. FIG. 2C is a table 206 illustrating an example of the locations and interconnections of nodes 110 between backbones 102 and 104. This example is also shown in FIG. 1A. In the example of FIG. 2C, nodes 110 in Los Angeles and Lima are connected with a generally north and south link 122, and nodes 110 in Singapore and Perth are connected with a generally north and south link 122. In other examples, other connections between nodes 110 in backbones 102 and 104 may be made.

As shown in FIG. 1B, nodes 110 each implement a dynamic routing protocol 112 that selects paths in backbones 102 and 104 for routing data. With the dynamic routing protocol 112, nodes 110 exchange information with other nodes 110 in the same or different backbone 102 and 104 that may be used to identify optimal paths between any two nodes 110. In one embodiment, dynamic routing protocol 112 is the Open Shortest Path First (OSPF) protocol and generally selects the shortest available path between nodes 110 to route data. In other embodiments, dynamic routing protocol 112 is another dynamic routing protocol and selects optimal paths in other ways.

Each node 110 connects to a different set of links 120(1)-120(M) where M is an integer that is greater than or equal to two and may be the same or different for different nodes 110. Links 120(1)-120(M) directly connect to a number of additional nodes 110 equal to or less than M. The number of additional nodes 110 may be less than M where multiple links 120 exist between nodes 110.

Each node 110 also connects to media sites 130(1)-130(N) across respectively connections 140(1)-140(N) where N is an integer that is greater than or equal to two and may be the same or different for different nodes 110. Media sites 130 each include any suitable type and number of data input, storage, and/or output devices such as computer, media storage, and A/V equipment in one embodiment. Media sites 130 provide data to node 110 for transmission on backbone 102 and/or 104 and receive data from node 110 that node 110 received from backbone 102 and/or 104. For example, each media site 130 may be configured to be included in a video teleconference with one or more additional media sites 130 connected to the same node 110 or another node 110. In other embodiments, media sites 130 may be replaced with other suitable data input, storage, and/or output sites that provide other types of non-media data to node 110 and receive other types of non-media data from node 110.

Each connection 140 may be any suitable transmission link or combination of redundant or non-redundant transmission links that allows communication between media site 130 and node 110. Each connection 140 may be formed from any suitable transmission medium (e.g., optical fiber, copper, and free space) and may transmit data using any suitable transmission protocol. In one embodiment, each connection 140 is an optical fiber link configured to transmit light signals between media site 130 and node 110. In other embodiments, each connection 140 is a wired or wireless link configured to transmit electromagnetic signals between media site 130 and node 110. Connections 140 may be any suitable combination of leased lines from telecommunications providers and lines owned by an operator of backbones 102 and 104 or by a third party. Connections 140 may also include any number of intermediate network devices (not shown) between media site 130 and node 110.

FIG. 3 is a flow chart illustrating an embodiment of a method for routing data on global communications ring backbones 102 and/or 104. The method of FIG. 3 will be described as being performed by a node 110 in backbone 102. Other nodes 110 in backbone 102 and nodes 110 in backbone 104 may also perform the method in one embodiment.

Node 110 receives data from a media site 130 across a connection 140 as indicated in a block 302. The data may be any suitable media or non-media data that is destined for another node 110 in backbone 102 or 104 or another media site 130 connected to another node 110 in backbone 102 or 104. The data may also be received directly from media site 130 or from an intermediate network device in connection 140. The node 110 that receives the data from media site 130 will be referred to hereafter as the source node 110 with reference to FIG. 3.

A determination is made by node 110 as to whether an optimal path from the source node 110 to a destination node 110 of the data is available as indicated in a block 304. Dynamic routing protocol 112 identifies the optimal path using a routing table (not shown) or other suitable routing information. Depending on the location of the source node 110 in backbone 102 and the location of the destination node 110 in backbone 102 or 104, the optimal path may include any number of links 120 and/or 122 and intermediate nodes 120. Where dynamic routing procotol 112 is the OSPF protocol, the optimal path may be the shortest path between the source node 110 and the destination node 110. With other protocols, the optimal path may be determined to be the fastest path or other suitable optimal path for a given a set of network conditions. In the example of FIG. 2A, an optimal path between nodes 110 in Chennai and New York may be the path from Chennai to London to New York.

Dynamic routing procotol 112 also determines whether the optimal path is available. The optimal path may be unavailable for one or more reasons that may include a failure of a node 110 or link 120 or 122 in the optimal path. In the above example where the optimal path between nodes 110 in Chennai and New York is assumed to be from Chennai to London and from London to New York, failure of the node 110 in London may make this path unavailable.

If the optimal path is available, then node 110 routes the data to the destination node 110 on the optimal path as indicated in a block 306. In the above example, the node 110 in Chennai routes the data to the node in London on the link 120 between Chennai and London and the node 110 in London routes the data to the node 1 10 in New York on the link 120 between London and New York.

If the optimal path is not available, then node 110 routes the data to the destination node 110 on an alternate path as indicated in a block 308. Continuing the example, the source node 110 may determine an alternate path between Chennai and New York to be the path from Chennai to Singapore to San Francisco to New York. Accordingly, the node 110 in Chennai routes the data to the node in Singapore on the link 120 between Chennai and Singapore, the node 110 in Singapore routes the data to the node 110 in San Francisco on the link 120 between Singapore and San Francisco, and the node 110 in San Francisco routes the data to the node 110 in New York on the link 120 between San Francisco and New York.

In the example just described, data was routed along backbone 102 from Chennai to New York using either a generally westbound route through London or a generally eastbound route through Singapore and San Francisco. In other examples, other optimal and alternate routes between Chennai and New York may include other nodes 110 in backbones 102 and/or 104.

FIG. 4 is a flow chart illustrating an embodiment of a method for routing data from global communications ring backbones 102 and/or 104. The method of FIG. 4 will be described as being performed by a node 110 in backbone 102. Other nodes 110 in backbone 102 and nodes 110 in backbone 104 may also perform the method in one embodiment.

Node 110 receives data from backbone 102 and/or 104 as indicated in a block 402 and routes the data to a media site 130 as indicated in a block 404. With the example just described, the node 110 in New York receives the data from backbone 102 that originated in a media site 130 connected to the node 110 in Chennai. The node 110 in New York routes the data to a media site 130 connected to the node 110 in New York across a connection 140. Data may, in turn, be routed from New York to Chennai using the methods of FIGS. 3 and 4 just described.

The above embodiments may provide for data communication with a guaranteed latency and inherent redundancy using one or more global communications ring backbones.

Although specific embodiments have been illustrated and described herein for purposes of description of the embodiments, it will be appreciated by those of ordinary skill in the art that a wide variety of alternate and/or equivalent implementations may be substituted for the specific embodiments shown and described without departing from the scope of the present disclosure. Those with skill in the art will readily appreciate that the present disclosure may be implemented in a very wide variety of embodiments. This application is intended to cover any adaptations or variations of the disclosed embodiments discussed herein. Therefore, it is manifestly intended that the scope of the present disclosure be limited by the claims and the equivalents thereof.

What is claimed is:

1. A system comprising:
a first node of a first global communications ring backbone that encircles Earth;
a first link of the first backbone connected to the first node and forming at least a portion of a first path that extends between the first node and a second node of the first backbone in a first direction in the first backbone; and
a second link of the first backbone connected to the first node and forming at least a portion of a second path that extends between the first node and the second node in a second direction in the first backbone that is substantially opposite of the first direction;
wherein the first node is configured to route first data to the second node using the first link, and wherein the first node is configured to route second data to the second node using the second link.

2. The system of claim 1 wherein the first path extends across a first set of lines of longitude between the first and the second nodes, and wherein the second path extends across a second set of lines of longitude between the first and the second nodes that differs from the first set.

3. The system of claim 2 wherein a combination of the first and the second sets includes substantially all of the lines of longitude.

4. The system of claim 1 wherein the first node is configured to route the first data to the second node using the first link in response to the first path being an optimal path between the first node and the second node, and wherein the first node is configured to route second data to the second node using the second link in response to the first path being unavailable.

5. The system of claim 1 further comprising:
a first media site configured to provide the first and the second data to the first node.

6. The system of claim 5 wherein the first and the second data includes first and second audio/video (A/V) media data, respectively, from a video teleconference between at least the first media site and a second media site connected to the second node.

7. The system of claim 1 wherein the first node is configured to receive the first and the second data from a third node of a second global communications ring backbone that encircles the Earth.

8. The system of claim 7 wherein the first and the second backbones encircle the Earth in different hemispheres of the Earth.

9. The system of claim 1 wherein the first backbone has a guaranteed average latency of less than 1 millisecond per degree of longitude of the Earth.

10. A method comprising:
routing first data from a first node of a first global communications ring backbone that encircles Earth to a second node of the backbone along a first path in the backbone that extends around the Earth between the first and the second nodes in a first direction in response to the first path being available; and
routing the first data from the first node to the second node along a second path in the backbone that extends around the Earth between the first and the second nodes in a second direction that is substantially opposite of the first direction in response to the first path being unavailable.

11. The method of claim 10 further comprising:
routing the first data from the first node to the second node along the first path in response to the first path being available and an optimal path between the first node and the second node.

12. The method of claim 10 wherein the first backbone has a guaranteed average latency of less than 1 millisecond per degree of longitude of the Earth

13. The method of claim 10 further comprising:
receiving the first data at the first node from a first media site;
wherein the first data is part of a video teleconference between the first media site and a second media site connected to the second hub.

14. The method of claim 13 further comprising:
receiving second data that is part of the video teleconference at the first node from the second node across the first backbone; and
providing the second data from the first node to the first media site.

15. The method of claim 10 further comprising:
receiving the data at the first node from a third path connected to a third node of a second global communications ring backbone that encircles the Earth.

16. The method of claim 15 wherein the first and the second backbones encircle the Earth in different hemispheres of the Earth.

17. A system comprising:
a first node of a global communications ring backbone that encircles a pole of Earth;
a first link of the backbone connected to the first node and forming at least a portion of a first path that extends between the first node and a second node of the backbone and across a first set of degrees of longitude of the Earth; and
a second link of the backbone connected to the first node and forming at least a portion of a second path that extends between the first node and the second node and across a second set of degrees of longitude of the Earth that differs from the first set;
wherein each of the first and the second paths is configured to have a guaranteed average latency of less than 1 millisecond per degree of longitude of the Earth.

18. The system of claim 17 a combination of the first and the second sets includes substantially all of the lines of longitude.

19. The system of claim 17 wherein the first and the second sets are substantially mutually exclusive.

20. The system of claim 17 wherein the first node is configured to route data to the second node on a shortest of the first and the second path.
